(19) United States
(12) Patent Application Publication
(10) Pub. No.: US 2022/0155856 A1
(43) Pub. Date: May 19, 2022

(54) Electronic Devices and Corresponding Methods for Initiating Electronic Communications with a Remote Electronic Device

(71) Applicant: Motorola Mobility LLC, Chicago, IL (US)

(72) Inventors: Amit Kumar Agrawal, Bangalore (IN); Alexandre Neves Creto, Sao Jose dos Campos (BR)

(21) Appl. No.: 16/951,809

(22) Filed: Nov. 18, 2020

(51) Int. Cl. G06F 3/01; G06F 3/0488; H04L 29/06; G06F 3/0482

(52) U.S. Cl. CPC G06F 3/013; G06F 3/0488; G06F 3/017; G06F 3/0482; H04L 65/1069

(57) ABSTRACT

An electronic device includes a display, one or more sensors, a communication device, one or more processors, and a memory. The one or more processors present an image from an image content file depicting representations of one or more persons on the display. The one or more sensors detect user input interacting with the display at one or more locations corresponding to the representations of the one or more persons. Thereafter, the one or more sensors detect a lifting gesture lifting the electronic device from a first position to a second, more elevated position. The one or more processors cause, in response to the one or more sensors detecting the user input and the lifting gesture, the communication device to initiate communication with one or more remote electronic devices associated with the one or more persons depicted in the image.

### BACKGROUND

### Technical Field

This disclosure relates generally to electronic devices, and more particularly to electronic devices with communication devices.

### Background Art

Smart, portable electronics, such as smartphones and smart tablets, are becoming increasingly sophisticated computing devices. In addition to being able to make voice calls and send text or multimedia messages, these devices are capable of executing financial transactions, recording, analyzing, and storing medical information, storing pictures and videos, maintaining calendars, to-do lists, and contact lists, and even performing personal assistant functions. Owners of such devices use the same for many different purposes including, but not limited to, voice communications and data communications, Internet browsing, commerce such as banking, and social networking.

As the technology of these devices has advanced, so too has their feature set. For example, not too long ago all electronic devices had physical keypads. Today touch sensitive displays are more frequently seen as user interface devices. It would be advantageous to have methods and systems simplifying the usage of these user interface devices. \

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device configured in accordance with one or more embodiments of the disclosure.

FIG. 3 illustrates another explanatory method in accordance with one or more embodiments of the disclosure.

FIG. 4 illustrates still another explanatory method in accordance with one or more embodiments of the disclosure.

FIG. 5 illustrates yet another explanatory method in accordance with one or more embodiments of the disclosure.

FIG. 6 illustrates one or more explanatory method steps in accordance with one or more embodiments of the disclosure.

FIG. 7 illustrates one or more explanatory prompts suitable for presentation on a display of an electronic device in accordance with one or more embodiments of the disclosure.

FIG. 8 illustrates another explanatory method in accordance with one or more embodiments of the disclosure.

FIG. 9 illustrates various embodiments of the disclosure. Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to initiating an electronic communication with a remote electronic device associated with a person presented in an image of an image content file, with that initiation of the electronic communication generally occurring in response to detecting both a user input and a lifting gesture. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself, as well as improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of initiating, with a communication device, a communication to one or more remote electronic devices in response to detecting a combined user input and lifting gesture occurring as described herein. The non-processor circuits may include, but are not limited to, a radio receiver, a radio transmitter, signal drivers, clock circuits, power source circuits, and user input devices.

As such, these functions may be interpreted as steps of a method to perform the initiation of the electronic communication to the one or more remote electronic devices in response to detecting the combined user input and lifting gesture. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide a simple, intuitive, and innovative method for initiating electronic communications between an electronic device and a remote electronic device. Rather than having to navigate through multiple screens, menus, applications, or other user interfaces of the electronic device, embodiments of the disclosure allow for an authorized user of an electronic device to initiate a call to a remote electronic device by delivering a simple user input, such as a gaze toward a display presenting an image from an image content file or a touch input at the display at a location along an image being presented from an image content file on a display, combined with a lifting gesture thereafter.

Illustrating by example, when one or more processors of the electronic device are presenting an image from an image content file on a display of the electronic device, with that image depicting a representation of a person, when one or more sensors of the electronic device detect the authorized user gazing at the depiction of the person, combined with the authorized user making a lift gesture lifting the electronic device from a first position to a second, more elevated position, the one or more processors of the electronic device cause a communication device to initiate an electronic communication with a remote electronic device belonging to the person depicted in the image in one or more embodiments. Advantageously, embodiments of the disclosure allow an authorized user of an electronic device to simply look at a person being depicted in an image on the display, and then lift the electronic device to their ear, to make a voice call to the person. This eliminates the need to navigate through contact lists, telephone applications, or take other multi-layered affirmative steps to place a call. Instead, in one or more embodiments the authorized user of the electronic device simply looks and lifts, which is all that is required to make a call.

In one or more embodiments, an electronic device comprises a display, one or more sensors, and a communication device. One or more processors are then operable with the display, the one or more sensors, and the communication device. In one or more embodiments, a memory is then operable with the one or more processors.

In one or more embodiments, the one or more processors present—on the display of the electronic device—an image from an image content file. In one or more embodiments the image depicts representations of one or more persons.

In one or more embodiments, the one or more sensors detect user input interacting with the display at one or more locations corresponding to the representations of the one or more persons. This user input can take a variety of forms. Illustrating by example, in one or more embodiments the user input comprises a user gaze being directed toward the display. In other embodiments, the user input comprises touch input being delivered to the display. Other examples of user inputs will be described below. Still others will be obvious to those of ordinary skill in the art having the benefit of this disclosure.

Thereafter, in one or more embodiments the one or more sensors detect a lifting gesture lifting the electronic device from a first position to a second, more elevated position. In one or more embodiments, the second, more elevated position is at least a foot above the first position. In one or more embodiments the one or more processors cause, in response to the one or more sensors detecting the user input and the lifting gesture, the communication device to initiate communication with one or more remote electronic devices associated with the one or more persons depicted in the image.

Advantageously, the authorized user of the electronic device can initiate electronic communications to a person depicted in an image simply by looking at the image (or touching the depiction of the person) and lifting the electronic device to their ear. There is no need to navigate from the image presentation application to a contact list application or telephone application, look up the person's telephone number or other communication identifier, enter that number or continuation identifier into a telephone application, hit send, and so forth. Instead, a simple look or touch, combined with a lift, is all that is needed to initiate the electronic communication.

It should be noted that while a voice communication in the form of a telephone call is used illustratively as a principal embodiment of an electronic communication, it will be obvious to those of ordinary skill in the art having the benefit of this disclosure that embodiments of the disclosure are not so limited. Electronic communications can take other forms as well, including text messaging, multimedia messaging, multimedia communications (e.g., video conferencing calls, etc.), and so forth. In one or more embodiments, the type of communication that is to be initiated based upon a detected user input/lift gesture combination can be defined using one or more settings or user preferences found in a menu of the electronic device.

In one or more embodiments, one or more sensors first determine that an authorized user is actively looking at the display while an image, one or more images, or video from an image content file are being presented on the display. In one or more embodiments, the image content file is a static file stored in the memory of the electronic device, which is in contrast to dynamic imagery that may occur, for example, when an imager is actively presenting a viewfinder stream at the display. Examples of such image content files can include static files such as pictures or videos stored in a memory as received from a file storage application, a photography/video application, a social media application, or other similar application of the electronic device. In one or more embodiments, this image from the image content file depicts a representation of one or more persons.

In one or more embodiments, one or more sensors of the electronic device then detect the receipt of user input interacting with the image or video. Where, for example, the image or video depicts only a single person, the user input can comprise a gaze of the authorized user of the electronic device being directed toward the display. By contrast, where the image or video depicts multiple people, the user input may comprise a touch input—optionally exceeding a predefined duration threshold—at a location corresponding to one or more of the persons depicted in the image.

In one or more embodiments, in response to the user input, the one or more processors of the electronic device begin processing the image or video being depicted on the display to identify the persons being depicted in the image or video. Illustrating by example, the one or more processors may cross reference the image with reference depictions of people of a contact list that is stored within the memory of the electronic device to perform facial recognition to link the identity of the person with a communication identifier—such as a telephone number —belonging to the person being depicted in the image or video.

Once this cross-referencing process that selects a communication identifier associated with a remote electronic device associated with a person or persons being depicted in the image(s) or video is complete, in one or more embodiments the one or more processors provide the authorized user of the electronic device an option to initiate electronic communications with the person or persons. The electronic communications may comprise a one-to-one telephone call with a single person, a group call, a video call, or other type of electronic communication with the person or persons depicted in the image or video.

In one or more embodiments, the initiation of this communication stems from the detection of a lifting gesture lifting the electronic device from a first position to a second, more elevated position. For instance, if the authorized user of the electronic device lifts the electronic device from their waist to their ear, thereby causing the electronic device to become more elevated by a predefined distance such as one foot, in one or more embodiments the one or more processors cause the communication device of the electronic device to initiate the electronic communication.

In one or more alternate embodiments, additional features can be provided. Illustrating by example, in one embodiment the one or more processors can present call options in the form of a prompt on the display in response to detecting the user input. The prompt may facilitate a selection of at least one person of the plurality of persons depicted in the plurality of representations for example. The prompt may facilitate a user selection of at least one person of a plurality of persons depicted the image or video. The prompt may instruct the authorized user to make the user selection of the at least one person. The prompt may further instruct the authorized user to make the lifting gesture lifting the electronic device from the first position to the second, more elevated position to initiate the electronic communication. These examples are illustrative only, as numerous other prompt examples will be obvious to those of ordinary skill in the art having the benefit of this disclosure. For instance, in some embodiments such as when the authorized user is wearing a headset, the prompt may facilitate the initiation of the electronic communication without the detection of the lifting gesture since the person may not need to lift the electronic device to hear audio from the electronic communication.

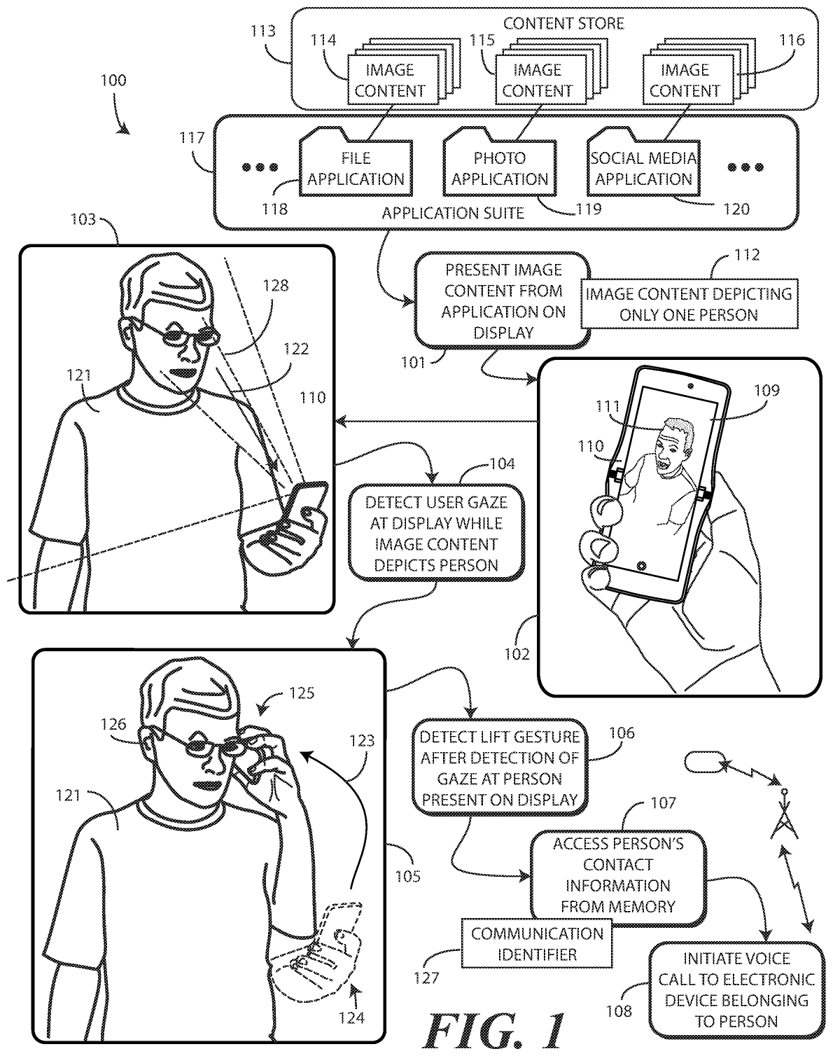

Turning now to FIG. 1, illustrated therein is one explanatory method 100 in accordance with one or more embodiments of the disclosure. Beginning at step 101, one or more processors of an electronic device 110 present on a display 109 of the electronic device 110 an image 111 of an image content file 112. The image 111 of the image content file 112 is shown at step 102. While an image 111 is used as an explanatory embodiment, it should be noted that video from the image content file 112 could be presented on the display 109 of the electronic device 110 rather that the image 111 in other embodiments.

In one or more embodiments, the image 111 of the image content file 112 depicts a representation of at least one person. In the illustrative embodiment of FIG. 1, the image 111 of the image content file 112 shown at step 102 depicts a representation of only one person.

In one or more embodiments, the image content file 112 is a static file stored in a content store 113 residing in a memory of the electronic device 110. This static file, which could be an image, one or more images, video, or combinations thereof, is stored in the content store 113 and is associated with an application of an application suite 117 operable on the one or more processors of the electronic device 110 in one or more embodiments. Examples of such applications of the application suite 117 shown illustratively in FIG. 1 include a file storage application 118, a photography or video application 119, and a social media application 120. Other examples of applications operable within the application suite 117 will be obvious to those of ordinary skill in the art having the benefit of this disclosure.

It should be noted that such image content files 112, being stored in the content store 113, are not real-time, dynamically occurring image presentations. The image content files 112 of the content store 113 are not, for example, dynamic presentations occurring when an imager of the electronic device 110 is actively presenting a viewfinder stream on the display of the electronic device 110. They are instead previously captured or created image(s) or videos that have been stored in the content store 113 by an application operating within the application suite 117.

Thus, if an authorized user 121 of the electronic device 110 had previously captured an image or video using an imager of the electronic device 110, and had then stored that image or video in the content store 113 using a photography or video application 119 operating in the application suite 117, this previously captured image or video could serve as an image content file 112 for presentation on the display 109 of the electronic device 110 at step 101 in one or more embodiments. However, if the authorized user 121 of the electronic device 110 were in the process of capturing an image, and the imager of the electronic device 110 were delivering real-time, dynamic streams to the display 109 in the form of a view-finder feature, those real-time, dynamic streams would not be suitable for use as the image content file 112 at step 101, and so forth.

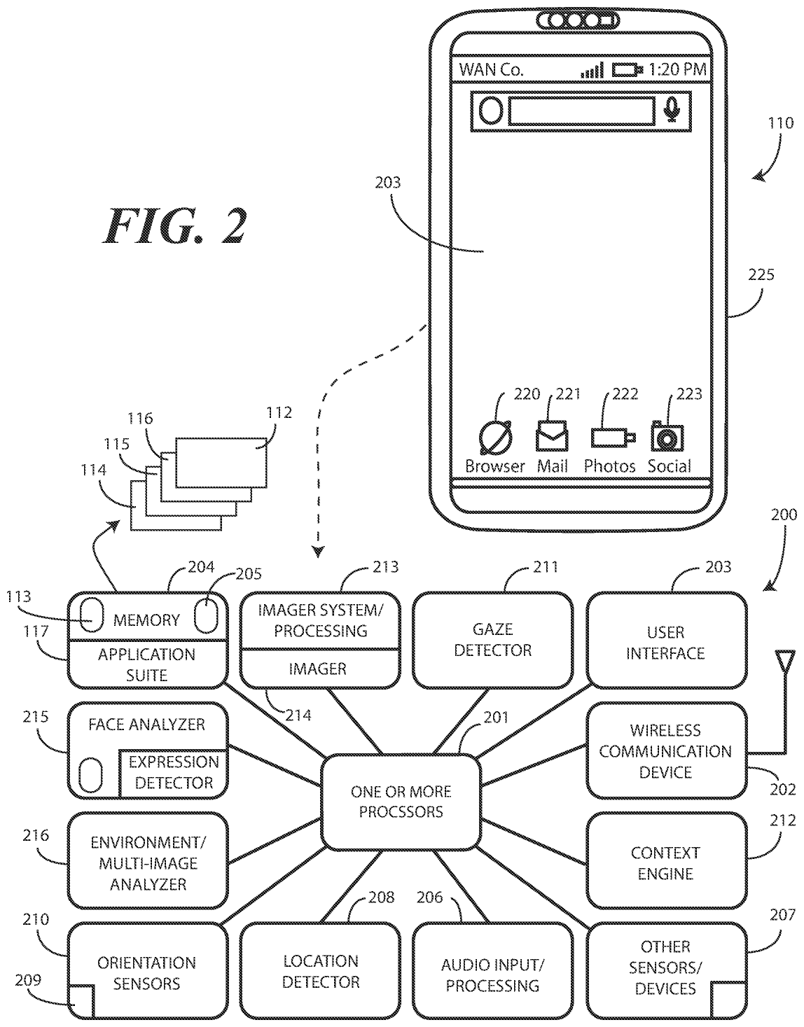

At step 103, the authorized user 121 is shown directing a user gaze 122 toward the display 109 of the electronic device 110. At step 104, a gaze detector of the electronic device 110, which will be described in more detail below with reference to FIG. 2, detects the user gaze 122 being directed toward the display 109 of the electronic device 110.

At step 105, the authorized user 121 executes a lift gesture 123 lifting the electronic device 110 from a first position 124 to a second position 125. In one or more embodiments, the second position 125 is at least a predefined distance above the first position 124. Illustrating by example, in one embodiment the second position 125 is at least six inches above the first position 124. In another embodiment, the second position is at least eight inches above the first position 124. In still another embodiment, the second position 125 is at least a foot above the first position 124. These predefined distances are illustrative only, as others will be obvious to those of ordinary skill in the art having the benefit of this disclosure.

In the illustrative embodiment of FIG. 1, the second position 125 is more elevated than is the first position 124. This allows the authorized user 121 to see the display 109 of the electronic device 110 when the electronic device 110 is in the first position 124, while being able to hear audio from an earpiece loudspeaker when the electronic device 110 is in the second position 125.

In the illustrative embodiment of FIG. 1, the second position 125 is adjacent to the ear 126 of the authorized user 121 in this illustrative embodiment. As will be described below with reference to FIG. 2, in one or more embodiments the electronic device 110 includes one or more proximity sensors. The one or more proximity sensors can detect the presence of objects, such as the ear 126, being proximately located with the display 109 or other parts of the electronic device 110. Where they are included, detecting such a proximity could be used as a condition precedent to initiating electronic communications in addition to the detection of the user input and the lift gesture.

At step 106, one or more motion sensors of the electronic device 110 detect the lift gesture 123 lifting the electronic device 110 from the first position 124 to the second position 125. In one or more embodiments, the one or more motion sensors of the electronic device 110 detect the lift gesture 123 increasing the elevation of the electronic device 110 by at least a predefined distance, such as one foot. In the illustrative embodiment of FIG. 1, step 106 occurs after step 104, which results in the one or more motion sensors detecting the lift gesture 123 lifting the electronic device 110 from the first position 124 to the second position 125 after the gaze detector detects the user gaze 122 being directed at the display 109 of the electronic device 110.

At step 107, one or more processors of the electronic device 110 retrieve, from a memory of the electronic device 110, a communication identifier 127 associated with a remote electronic device belonging to the person being depicted in the image 111 of the image content file 112 being presented on the display 109 of the electronic device 110. In one or more embodiments, step 107 occurs in response to the gaze detection occurring at step 104 and the lift gesture 123 detection occurring at step 106.

Step 107 can occur in a variety of ways. Illustrating by example, the one or more processors of the electronic device 110 can begin processing the image 111 of the image content file 112 being presented on the display 109 of the electronic device 110 to identify the person being depicted therein. At step 107, the one or more processors of the electronic device 110 may cross reference the image 111 with depictions stored in a contact application of the application suite 117, or with a contact list stored within the memory of the electronic device 110, to perform facial recognition to link the identity of the person with the communication identifier 127 (one example of which is a telephone number) associated with a remote electronic device belonging to the person being depicted in the image 111 of the image content file 112. Other techniques for selecting the communication identifier 127 will be obvious to those of ordinary skill in the art having the benefit of this disclosure. Once the cross-referencing process of step 107 that selects the communication identifier 127 associated with the remote electronic device associated with a person (here, only a single person) being depicted in the image 111 of the image content file 112 is complete, the method 100 moves to step 108.

In one or more embodiments, step 108 comprises the one or more processors of the electronic device 110 initiating an electronic communication with the remote electronic device associated with the person being depicted in the image 111 of the image content file 112. In one or more embodiments, step 108 occurs in response to both the detection of the user gaze 122 being directed toward the display 109 of the electronic device 110 at step 104 and the detection of the lift gesture 123 lifting the electronic device 110 from the first position 124 to the second position 125 at step 106. As noted above, step 108 can be conditioned upon other inputs, such as when one or more proximity sensors detect the ear 126 being proximately located with the electronic device 110, and so forth.

In one or more embodiments, the initiation of the electronic communication occurring at step 108 employs the communication identifier 127 selected at step 107. For example, where the communication identifier 127 is a telephone number, the initiation of the electronic communication occurring at step 108 can employ the telephone number to initiate a voice call to the remote electronic device.

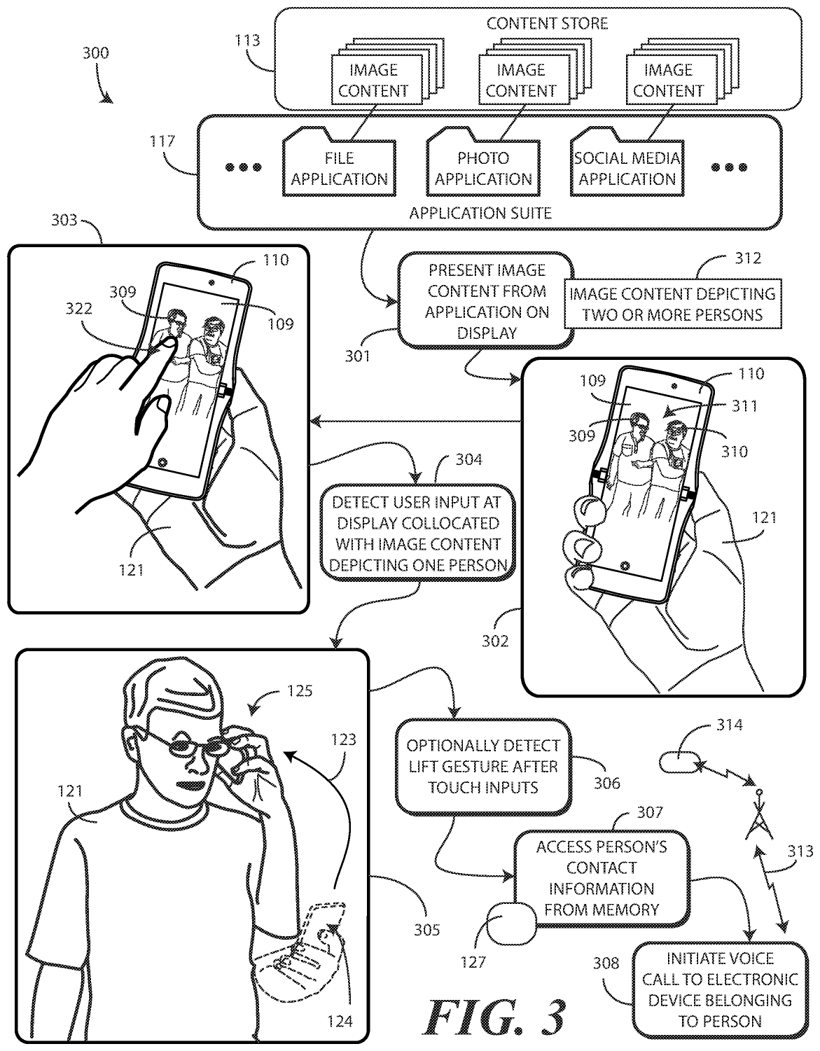

The electronic communication initiated at step 108 can take a variety of forms. Illustrating by example, in one or more embodiments the electronic communication may comprise a one-to-one telephone call with the single person depicted in the image 111 of the image content file 112. Alternatively, the electronic communication initiated at step 108 could be a video call with the single person being depicted in the image 111 of the image content file 112. As will be described below with reference to FIGS. 3-5, in other embodiments the image 111 can depict multiple persons. Accordingly, the electronic communication initiated can comprise a group telephone call, a group video call, or other type of electronic communication with the person or persons depicted in the image 111. Other examples of electronic communications that can be initiated at step 108 will be obvious to those of ordinary skill in the art having the benefit of this disclosure.

As illustrated and described in FIG. 1, in one or more embodiments where a single person is depicted in an image 111 of an image content file 112 that is being presented on the display 109 of the electronic device 110, all an authorized user 121 of the electronic device 110 need do to initiate an electronic communication with a remote electronic device, e.g., a smartphone belonging to the single person, is simply look (deliver the user gaze 122 toward the display 109 of the electronic device 110 at step 103) and lift (execute the lifting gesture 123 lifting the electronic device 110 from the first position 124 to the second position 125). There is no need to manually switch from the presentation of the image 111 of the image content file 112 to another application, such as an address book, manually look up the communication identifier 127, switch to another application, such a telephone application, enter the communication identifier 127, and then manually initiate the electronic communication. Instead, all that is required is a look (step 103) and a lift (step 105). In response thereto, one or more processors of the electronic device 110 initiate communication with a remote electronic device belonging to the person depicted in the image 111 of the image content file 112 being presented on the display 109 of the electronic device 110. The method 100 of FIG. 1 advantageously provides an intuitive, frictionless, and simple way to initiate an electronic communication.

Turning now to FIG. 2, illustrated therein is one explanatory block diagram schematic 200 of one explanatory electronic device 110 configured in accordance with one or more embodiments of the disclosure. It should be noted that the illustrative block diagram schematic 200 of FIG. 2 includes many different components. Embodiments of the disclosure contemplate that the number and arrangement of such components can change depending on the particular application. For example, a wearable electronic device may have fewer, or different, components from a non-wearable electronic device. Accordingly, electronic devices configured in accordance with embodiments of the disclosure can include some components that are not shown in FIG. 2, and other components that are shown may not be needed and can therefore be omitted.

Additionally, the electronic device 110 can be one of various types of devices. In one embodiment, the electronic device 110 is a portable electronic device, one example of which is a smartphone that will be used in the figures for illustrative purposes. However, it should be obvious to those of ordinary skill in the art having the benefit of this disclosure that the block diagram schematic 200 could be used with other devices as well, including palm-top computers, tablet computers, gaming devices, media players, wearable devices, or other devices. Illustrating by example, the electronic communication initiated by one or more processors 201 of the electronic device 110 using the communication device 202 could be an exchange of gaming signals allowing an authorized user (121) of the electronic device 110 to compete in head to head gaming where the electronic device 110 is configured as a gaming device. Still other devices will be obvious to those of ordinary skill in the art having the benefit of this disclosure.

In one or more embodiments, the block diagram schematic 200 is configured as a printed circuit board assembly disposed within a housing 225 of the electronic device 110. Various components can be electrically coupled together by conductors or a bus disposed along one or more printed circuit boards.

The illustrative block diagram schematic 200 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 200 includes a user interface 203. In one or more embodiments, the user interface 203 includes a display 109, which may optionally be touch-sensitive. In one embodiment, users can deliver user input to the display 109 of such an embodiment by delivering touch input from a finger, stylus, or other objects disposed proximately with the display 109. In one embodiment, the display 109 is configured as an active matrix organic light emitting diode (AMOLED) display. However, it should be noted that other types of displays, including liquid crystal displays, would be obvious to those of ordinary skill in the art having the benefit of this disclosure.

In one embodiment, the electronic device includes one or more processors 201. In one embodiment, the one or more processors 201 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 200. Each of the application processor and the auxiliary processor(s) can be configured to process and execute executable software code to perform the various functions of the electronic device with which the block diagram schematic 200 operates.

A storage device, such as memory 204, can optionally store the executable software code used by the one or more processors 201 during operation. In one or more embodiments, the memory 204 comprises a content store 113 and an application suite 117, each of which was described above with reference to FIG. 1. One or more image content files 112,114,115,116, which can each comprise a single image, multiple images, video, multimedia content, or other content, can be stored within the content store 113. These image content files 112,114,115,116 can be associated with applications that are operable in the application suite 117, examples of which include a file storage application (118), a photography or video application (119), and a social media application (120), as previously noted. Other examples of applications operable within the application suite 117 will be obvious to those of ordinary skill in the art having the benefit of this disclosure.

In one or more embodiments, the image content files 112,114,115,116 being stored in the content store 113 are not real-time, dynamically occurring image presentations. The image content files 112,114,115,116 of the content store 113 are not dynamic presentations occurring when an imager of the electronic device 110 presents a view-finder presentation on the display 109 prior to capturing an image content file. They are instead previously captured or created image(s) or videos that have been stored in the content store 113 by an application operating within the application suite 117.

In this illustrative embodiment, the block diagram schematic 200 also includes a communication device 202 that can be configured for wired or wireless communication with one or more other devices or networks. The networks can include a wide area network, a local area network, and/or personal area network. The communication device 202 may also utilize wireless technology for communication, such as, but are not limited to, peer-to-peer or ad hoc communications such as HomeRF, Bluetooth and IEEE 802.11; and other forms of wireless communication such as infrared technology. The communication device 202 can include wireless communication circuitry, one of a receiver, a transmitter, or transceiver, and one or more antennas.

In one embodiment, the one or more processors 201 can be responsible for performing the primary functions of the electronic device with which the block diagram schematic 200 is operational. For example, in one embodiment the one or more processors 201 comprise one or more circuits operable with the user interface 203 to present presentation information to a user. The executable software code used by the one or more processors 201 can be configured as one or more modules 205 that are operable with the one or more processors 201. Such modules 205 can store instructions, control algorithms, and so forth.

In one or more embodiments, the block diagram schematic 200 includes an audio input/processor 206. The audio input/processor 206 can include hardware, executable code, and speech monitor executable code in one embodiment. The audio input/processor 206 can include, stored in memory 204, basic speech models, trained speech models, or other modules that are used by the audio input/processor 206 to receive and identify voice commands that are received with audio input captured by an audio capture device. In one embodiment, the audio input/processor 206 can include a voice recognition engine. Regardless of the specific implementation utilized in the various embodiments, the audio input/processor 206 can access various speech models to identify speech commands in one or more embodiments.

Various sensors 207 can be operable with the one or more processors 201. FIG. 2 illustrates several examples such sensors 207. It should be noted that those shown in FIG. 2 are not comprehensive, as others will be obvious to those of ordinary skill in the art having the benefit of this disclosure. Additionally, it should be noted that the various sensors shown in FIG. 2 could be used alone or in combination. Accordingly, many electronic devices will employ only subsets of the sensors shown in FIG. 2, with the particular subset defined by device application.

A first example of a sensor that can be included with the other sensors 207 is a touch sensor. The touch sensor can include a capacitive touch sensor, an infrared touch sensor, resistive touch sensors, or another touch-sensitive technology.

The one or more other sensors 207 may also include key selection sensors, a touch pad sensor, a touch screen sensor, a capacitive sensor, and one or more switches. Touch sensors may be used to indicate whether any of the user actuation targets 220,221,222,223 on present on the display 109 are being actuated. Alternatively, touch sensors in the housing 225 can be used to determine whether the electronic device 110 is being touched at side edges, thus indicating whether certain orientations or movements of the electronic device 110 are being performed by a user. The other sensors 207 can also include surface/housing capacitive sensors, audio sensors, and video sensors (such as a camera).

Another example of a sensor that can be included with the one or more other sensors 207 is a geo-locator that serves as a location detector 208. In one embodiment, location detector 208 is able to determine location data of the electronic device 110 by capturing the location data from a constellation of one or more earth orbiting satellites, or from a network of terrestrial base stations to determine an approximate location. The location detector 208 may also be able to determine location by locating or triangulating terrestrial base stations of a traditional cellular network, or from other local area networks, such as Wi-Fi networks.

One or more motion sensors 209 can be configured as an orientation detector 210 that determines an orientation and/or movement of the electronic device 110 in three-dimensional space. Illustrating by example, the orientation detector 210 can include an accelerometer, gyroscopes, or other device to detect device orientation and/or motion of the electronic device 110. In one or more embodiments, the orientation detector 210 can be used to detect a lift gesture (123) lifting the electronic device 110 from a first position (124) to a second position (125). Using an accelerometer as an example of one of the one or more motion sensors 209, an accelerometer can be included to detect motion of the electronic device 110. Additionally, the accelerometer can be used to sense some of the gestures of the user, such as one talking with their hands, running, walking, or executing a lift gesture (123). The orientation detector 210 can also optionally determine a distance between the first position (124) and the second position (125).

The orientation detector 210 can determine the spatial orientation of an electronic device 110 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 110.

In one or more embodiments, the other sensors 207 and the motion sensors 209 can each be used as a gesture detection device. Illustrating by example, in one embodiment a user can deliver gesture input by moving a hand or arm in predefined motions in close proximity to the electronic device 110. In another embodiment, the user can deliver gesture input by touching the display 109. In yet another embodiment, a user can deliver gesture input by shaking or otherwise deliberately moving the electronic device 110. Other modes of delivering gesture input will be obvious to those of ordinary skill in the art having the benefit of this disclosure

A gaze detector 211 can comprise sensors for detecting the user's gaze point. The gaze detector 211 can, for example, be used to detect the user gaze (122) at step (104) of FIG. 1. The gaze detector 211 can optionally include sensors for detecting the alignment of a user's head in three-dimensional space. Electronic signals can then be processed for computing the direction of user gaze (122) in three-dimensional space. The gaze detector 211 can further be configured to detect a gaze cone (128) corresponding to the detected gaze direction, which is a field of view within which the user may easily see without diverting their eyes or head from the detected gaze direction. The gaze detector 211 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 211 of FIG. 2.

Other sensors 207 operable with the one or more processors 201 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

As noted above, the other sensors 207 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 225 of the electronic device 110. In one embodiment, the signal receiver is an infrared signal receiver to receive an infrared emission from an object such as a human being when the human is proximately located with the electronic device 110.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other sensors 207 can optionally include a barometer operable to sense changes in air pressure due to elevation changes or differing pressures of the electronic device 110. The other sensors 207 can also optionally include a light sensor that detects changes in optical intensity, color, light, or shadow in the environment of an electronic device. The other sensors 207 can optionally include an altimeter configured to determine changes in altitude experienced by the electronic device 110, such as when a lift gesture (123) lifts the electronic device 110 from a first position (124) to a second position (125). Similarly, a temperature sensor can be configured to monitor temperature about an electronic device.

A context engine 212 can then operable with the various sensors to detect, infer, capture, and otherwise determine persons and actions that are occurring in an environment about the electronic device 110. For example, where included one embodiment of the context engine 212 determines assessed contexts and frameworks using adjustable algorithms of context assessment employing information, data, and events. These assessments may be learned through repetitive data analysis. Alternatively, an authorized user (121) of the electronic device 110 may employ the user interface 203 to enter various parameters, constructs, rules, and/or paradigms that instruct or otherwise guide the context engine 212 in detecting multi-modal social cues, emotional states, moods, and other contextual information. The context engine 212 can comprise an artificial neural network or other similar technology in one or more embodiments.

In one or more embodiments, the context engine 212 is operable with the one or more processors 201. In some embodiments, the one or more processors 201 can control the context engine 212. In other embodiments, the context engine 212 can operate independently, delivering information gleaned from detecting multi-modal social cues, emotional states, moods, and other contextual information to the one or more processors 201. The context engine 212 can receive data from the various sensors. In one or more embodiments, the one or more processors 201 are configured to perform the operations of the context engine 212.

An authentication system 213 can be operable with an imager 214. In one embodiment, the imager 214 comprises a two-dimensional imager configured to receive at least one image of a person within an environment of the electronic device 110. In one embodiment, the imager 214 comprises a two-dimensional RGB imager. In another embodiment, the imager 214 comprises an infrared imager. Other types of imagers suitable for use as the imager 214 of the authentication system 213 will be obvious to those of ordinary skill in the art having the benefit of this disclosure.

The authentication system 213 can be operable with a face analyzer 215 and an environmental analyzer 216. The face analyzer 215 and/or environmental analyzer 216 can be configured to process an image of an object and determine whether the object matches predetermined criteria. For example, the face analyzer 215 and/or environmental analyzer 216 can operate as an identification module configured with optical and/or spatial recognition to identify objects using image recognition, character recognition, visual recognition, facial recognition, color recognition, shape recognition, and the like. Advantageously, the face analyzer 215 and/or environmental analyzer 216, operating in tandem with the authentication system 213, can be used as a facial recognition device to determine the identity of one or more persons detected about the electronic device 110, or alternatively depicted in one or more images presented on the display 109.

In one or more embodiments, the face analyzer 215 can be used to identify persons being depicted in an image (111) of an image content file 112 at step (107) of FIG. 1 as previously described. Illustrating by example, in one embodiment when an image (111) of an image content file 112 is being presented on the display 109 of the electronic device 110, the face analyzer 215 can perform an image analysis operation on the image (111) of an image content file 112. This can be done in a variety of ways.

In a simple embodiment, the face analyzer 215 can compare the image (111) to one or more predefined authentication reference images stored in the memory 204. This comparison, in one or more embodiments, is used to confirm beyond a threshold authenticity probability that the person's face being depicted in the image (111) of the image content file 112 sufficiently matches one or more of the reference files. In another embodiment, the face analyzer 215 can compare the image (111) of the image content file 112—or one or more parameters extracted from the image (111) of the image content file 112—to parameters of a neural network. Accordingly, in one or more embodiments the face analyzer 215 can compare data from the image (111) of the image content file 112 to one or more predefined reference images and/or predefined authentication references and/or mathematical models to determine beyond a threshold authenticity probability that the person's face being depicted in the image (111) of the image content file 112 is the face of an identifiable person.

Beneficially, this optical recognition performed by the face analyzer 215, optionally in tandem with the authentication system 213 and/or environmental analyzer 216, allows the one or more processors 201 of the electronic device 110 to identify persons depicted in the image (111) of the image content file 112 when the same is being presented on the display 109 of the electronic device 110. Accordingly, in one or more embodiments the one or more processors 201, working with the authentication system 213 and/or the face analyzer 215 and/or the environmental analyzer 216, can determine whether characteristics of the image (111) of the image content file 112 match one or more predefined criteria. In one or more embodiments, where they do, this information can be used to select a communication identifier (127) belonging to an electronic device associated with a person being depicted in the image (111) of the image content file 112 so that electronic communication with that electronic device can be established. In one or more embodiments, this establishment of the electronic communication occurs in response to the one or more sensors 207 of the electronic device detecting a user input in combination with a lift gesture (123) as previously described.

As noted above, the one or more processors 201, operating in conjunction with the authentication system 213, can also determine whether there is a depiction of at least one predefined person in image (111) of the image content file 112. The one or more processors 201, operating with the authentication system 213, can then compare depictions of any identified persons to one or more authentication references stored in the memory 204 of the electronic device 110. Where there is a depiction of at least one person in an image (111) of the image content file 112, the one or more processors 201 can cause, in response to the one or more sensors 207 detecting one or more of user input—such as a user gaze (122) or touch input—and a lift gesture (123), initiation of an electronic communication with a remote electronic device belonging to the at least one person being depicted in the image (111) of the image content file 112.

It should be noted that the block diagram schematic 200 of FIG. 2 is provided for illustrative purposes only and for illustrating components of one electronic device 110 in accordance with embodiments of the disclosure, and is not intended to be a complete schematic diagram of the various components required for an electronic device 110. Therefore, other electronic devices in accordance with embodiments of the disclosure may include various other components not shown in FIG. 2, or may include a combination of two or more components or a division of a particular component into two or more separate components, and still be within the scope of the present disclosure.

Turning now to FIG. 3, illustrated therein is another method 300 configured in accordance with one or more embodiments of the disclosure. As with the method (100) of FIG. 1, at step 301 one or more processors of an electronic device 110 present on a display 109 of the electronic device 110 an image 311 of an image content file 312, which is shown at step 302. Again, while a single, static image 311 is used in FIG. 3 for explanatory purposes, embodiments of the disclosure are not so limited. Rather than a single, static image, image 311 could be replaced with multiple images, video, or other content of the image content file 312.

As before, regardless of whether the image content file 312 includes a single image, multiple images, video or other content, in this illustrative embodiment the image content file 312 is a static file stored in a content store 113 residing in a memory (204) of the electronic device 110. In one or more embodiments, the static file is associated with an application of an application suite 117 operable on the one or more processors (201) of the electronic device 110. Accordingly, the image content file 312 is not a real-time, dynamically occurring image presentation such as that which would be occurring if an imager of the electronic device 110 were actively presenting a viewfinder stream on the display 109 of the electronic device 110. The image 311 of this embodiment is instead a previously captured or created image(s) or video(s) that have been stored in the content store 113 by an application operating within the application suite 117.

In one or more embodiments, the image 311 of the image content file 312 depicts representations of one or more persons. While the image (111) of the image content file (112) of FIG. 1 illustrated only a single person, in the illustrative embodiment of FIG. 3 the image 311 of the image content file 312 depicts a plurality of persons, namely, a first person 309 and a second person 310.

As before, to provide a simple, intuitive, and frictionless electronic communication initiation feature, one or more sensors (207) of the electronic device detect user input interacting with the display 109 at one or more locations corresponding to the representations of the first person 309 and the second person 310 on the display 109. Since there are two people depicted in the image 311 of the image content file 312 in this illustrative embodiment, the user interaction can occur in multiple ways.

If, for example, one person of the first person 309 or the second person 310 is the authorized user 121 of the electronic device 110, the user input interacting with the display 109 could take the form of user gaze in one or more embodiments. Embodiments of the disclosure contemplate that the authorized user 121 of the electronic device 110 would not generally intend to call himself when holding the electronic device 110 in his hand. Accordingly, in one or more embodiments where two people are depicted in the image 311 of the image content file 312, with one of those people being the authorized user 121 of the electronic device, a gaze detector (211) of the electronic device 110 can detect the user input interacting with the display 109 by detecting a user gaze (122) being directed toward the display 109 of the electronic device 110. Moreover, where the representations of the one or more persons comprise a plurality of representations of a plurality of persons, with the plurality of representations comprising a representation of an authorized user of the electronic device, electronic communication will only be initiated with one or more remote electronic devices are associated with persons other than the authorized user of the electronic device in one or more embodiments.

When none of the people being depicted in the image 311 of the image content file 312 are the authorized user 121 of the electronic device 110, the user input interacting with the display 109 of the electronic device 110 can still be user gaze (122) where the resolution and accuracy of the gaze detector (211) is sufficient to determine whether the user gaze (122) is directed at the first person 309 or the second person 310. Where there is sufficient accuracy, the method 300 of FIG. 3 can occur in a substantially similar manner to the method (100) of FIG. 1, in which the authorized user 121 of the electronic device 110 simply looks at either the first person 309 or the second person 310 to provide user input interacting with the display 109 at one or more locations corresponding to the representations of the first person 309 or the second person 310. The authorized user 121 then makes a lift gesture 123 to cause the one or more processors (201) of the electronic device 110 to cause the communication device (202) to initiate an electronic communication with a remote electronic device associated with whichever of the first person 309 or the second person 310 the authorized user 121 of the electronic device 110 has directed their user gaze (122).

However, embodiments of the disclosure contemplate that in some conditions the accuracy and resolution of the gaze detector (211) may be insufficient to distinguish whether the user gaze (122) is being directed at the first person 309 or the second person 310. In such cases, other user input can be detected interacting with the display 109. Illustrating by example, at step 303 the authorized user 121 is delivering user input 322 interacting with the display 109 by delivering touch input to a location corresponding to the representation of the first person 309. This touch input selects the first person 309 as the person with whom the authorized user 121 of the electronic device 110 would like to initiate a voice call.

The user input 322 could take other forms as well. Illustrating by example, in another embodiment the user input 322 occurring at step 303 could be that of a gesture near the display 109 at a location corresponding to the first person 309. The authorized user 121 may, for example, sweep a finger or hand above the first person 309 to deliver the user input 322.

In still another embodiment, the user input 322 interacting with the display 109 at a location corresponding to a representation of a person in the image 311 of the image content file 312 could be voice input. The authorized user 121 of the electronic device 110 may say, “call the guy on the left,” and so forth. Other examples of user input 322 interacting with the display 109 at such locations will be obvious to those of ordinary skill in the art having the benefit of this disclosure. Regardless of the type of user input occurring at step 303, at step 304 one or more sensors (207) of the electronic device detect the user input 322 interacting with the display 109 at one or more locations corresponding to the representations of the one or more persons being depicted in the image 311 of the image content file 312.

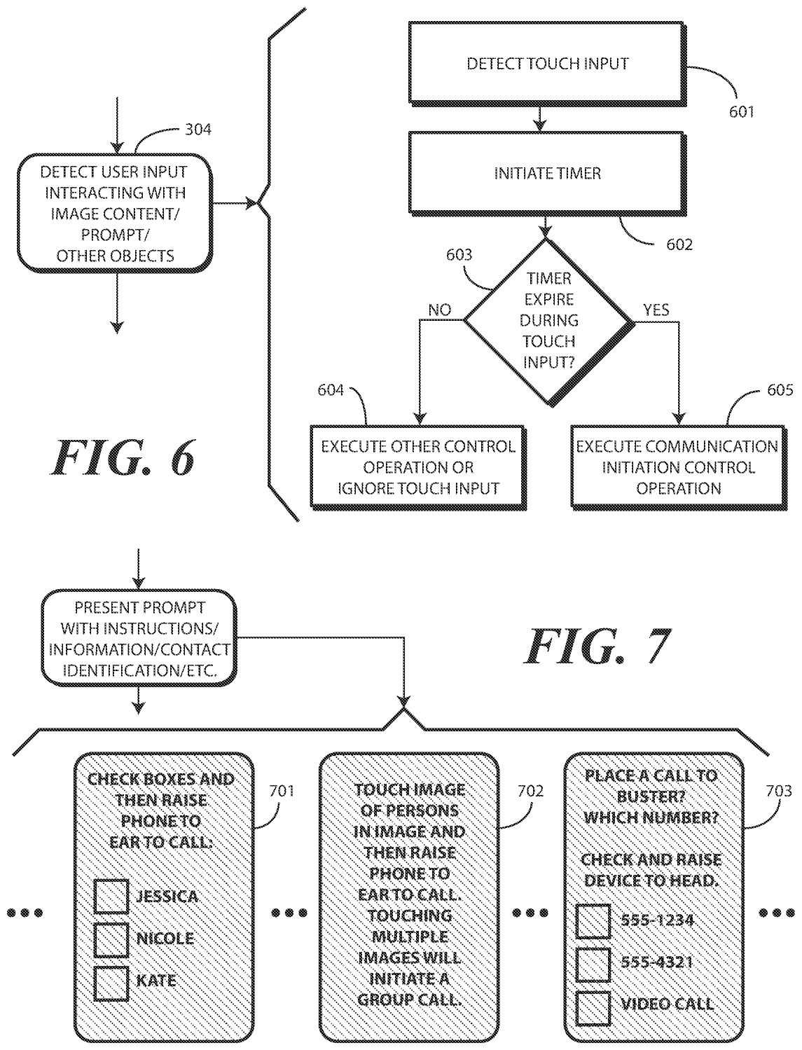

In the illustrative embodiment of FIG. 3, at step 303 the authorized user 121 of the electronic device 110 touches the display 109 at a predefined location, which in this illustration is atop the depiction of the first person 309. In one or more embodiments, to prevent accidental triggering, the method 300 can require that the authorized user 121 deliver the user input 322 for at least a predetermined duration. This ensures that the authorized user 121 is intentionally delivering the user input to the electronic device 110, as opposed to merely accidentally brushing a finger or other object across the display 109 of the electronic device 110.

Where this additional false trip protection is included, step 304 can include determining that the user input 322 occurred for at least a predetermined duration, such as 300 milliseconds, 500 milliseconds, one, two, or three seconds. Turning now briefly to FIG. 6, illustrated therein is one explanatory method of how step 304 can occur.

As shown in FIG. 6, in one or more embodiments step 304 comprises detecting an initial touch input at the display (109) of the electronic device (110) at step 601. In one or more embodiments, when this initial touch input is detected, one or more processors (201) of the electronic device (110) initiate a timer at step 602. If, for example, the predefined duration during which the touch input must occur is 350 milliseconds, step 602 can comprise the one or more processors (201) of the electronic device (110) initiating the timer for that duration.

Decision 603 determines whether the timer has expired while the touch input is still occurring. Where it has, i.e., where the touch input duration exceeds the timer duration, step 304 comprises executing a control operation at step 605. In one or more embodiments, the control operation comprises confirming that the touch input occurred for at least the predetermination. Said differently, in one or more embodiments the control operation comprises indicating that the touch input occurred for at least the predefined duration. The control operation can also include presenting selection confirmation identifiers, at the display, indicating that a user actuation target or image portion has been selected, thereby confirming that the touch input occurred for at least the predefined duration.

By contrast, where the timer fails to expire during the touch input, as determined at decision 603, step 304 can move to step 604 where another control operation is executed. In one or more embodiments, the control operation of step 604 comprises ignoring the touch input since it did not occur for the predefined duration.

Turning now back to FIG. 3, at step 305 the authorized user 121 executes a lift gesture 123 lifting the electronic device 110 from a first position 124 to a second position 125. As with the embodiment of FIG. 1, in the illustrative embodiment of FIG. 3, the second position 125 is more elevated than is the first position 124 and may optionally be required to be more elevated by a predefined distance such as ten inches. This allows the authorized user 121 to see the display 109 of the electronic device 110 when the electronic device 110 is in the first position 124, while being able to hear audio from an earpiece loudspeaker when the electronic device 110 is in the second position 125, as previously described.

At step 306, one or more motion sensors (209) of the electronic device 110 detect the lift gesture 123 lifting the electronic device 110 from the first position 124 to the second position 125. In the illustrative embodiment of FIG. 3, step 306 occurs after step 304, which results in the one or more motion sensors (209) detecting the lift gesture 123 lifting the electronic device 110 from the first position 124 to the second position 125 after the one or more sensors (207) detect the user input 322 interacting with the display 109 at one or more locations corresponding to the representations of the one or more persons depicted in the image 311 of the image content file 312.

At step 307, one or more processors (201) of the electronic device 110 retrieve, from a memory (204) of the electronic device 110, a communication identifier 127 associated with a remote electronic device belonging to the first person 309, who was selected by the authorized user 121 via the user input 322 delivered at step 303. In one or more embodiments, step 307 occurs in response to the detection of the user input at step 304 and the detection of the lift gesture 123 detection occurring at step 306.

Step 307 can occur in a variety of ways. In one or more embodiments, the one or more processors (201) of the electronic device 110 can perform an image analysis, optionally using the face analyzer (215), environmental analyzer (216), authentication system (213), or other components, to determine whether the depiction of the first person 309 occurring in the image 311 of the image content file 312 sufficiently corresponds to one or more reference images stored in the memory (204) of the electronic device 110.

In one or more embodiments, the one or more processors (201) employ a library of reference images to compare the image 311 of the image content file 312 to determine if the latter substantially matches the former. The one or more processors (201) can use the library to quickly find visually similar images, even if they have been resized, recompressed, recolored, or slightly modified.

Where there is a sufficient match, step 307 can comprise the one or more processors (201) selecting a communication identifier 127 associated with the person identified by the user input 322 received at step 303, which in this example is the first person 309. In one or more embodiments, the communication identifier 127 comprises a telephone number corresponding to a remote electronic device belonging to the first person 309. However, it should be noted that the communication identifier 127 can take a variety of forms. Illustrating by example, in one embodiment the communication identifier 127 comprises an email address. In another embodiment, the communication identifier 127 comprises a fax number. In another embodiment, the communication identifier 127 comprises a social media identifier. Other communication identifiers will be obvious to those of ordinary skill in the art having the benefit of this disclosure. For example, a non-traditional communication identifier may be a short-wave radio address, and so forth.

In one or more embodiments, the communication identifier 127 selected is user configurable. For example, in one embodiment the authorized user 121 can set a flag in the settings of the electronic device 110 so that the one or more processors (201) of the electronic device 110 always determine a particular type of communication identifier, such as a text message address that may be suitable for delivering an audio message to the same, when determining the communication identifier 127 associated with the first person 309 depicted in the image 311 of the image content file 312. In another embodiment, where there are multiple communication identifiers associated with the first person 309, the authorized user 121 of the electronic device 110 can be prompted on the display 109 of the electronic device 110 regarding which communication identifier they would like to select. An example of this will be described in more detail below with reference to FIG. 7. In still other embodiments, the communication identifier 127 that the one or more processors (201) should select is set by the manufacturer and is not user selectable.

In other embodiments, the one or more processors (201) of the electronic device 110 can perform visual image analysis on the image 311 of the image content file 312 to identify the first person 309. At step 307, the one or more processors (201) of the electronic device 110 may cross reference the image 311 with depictions stored in a contact application of the application suite 117, or with a contact list stored within the memory (204) of the electronic device 110 to perform facial recognition to link the identity of the first person 309 with the communication identifier 127. Other techniques for selecting the communication identifier 127 will be obvious to those of ordinary skill in the art having the benefit of this disclosure.

Once the selection process of step 307 selects the communication identifier 127 associated with the remote electronic device associated with the first person 309 is complete, the method 300 moves to step 308. In one or more embodiments, step 308 comprises the one or more processors (201) of the electronic device 110 causing the communication device (202) to initiate an electronic communication 313 with the remote electronic device 314 associated with the first person 309. In one or more embodiments, step 308 occurs in response to both the detection of the user input 322 interacting with the display 109 of the electronic device 110 at step 304 and the detection of the lift gesture 123 lifting the electronic device 110 from the first position 124 to the second position 125 at step 306. In one or more embodiments, the initiation of the electronic communication 313 occurring at step 308 employs the communication identifier 127 selected at step 307. For example, where the communication identifier 127 is a telephone number, the initiation of the electronic communication 313 occurring at step 308 can employ the telephone number to initiate a voice call to the remote electronic device 314.

The electronic communication 313 initiated at step 308 can take a variety of forms. Illustrating by example, in one or more embodiments the electronic communication 313 may comprise a one-to-one telephone call with the remote electronic device 314 belonging to the first person 309. Alternatively, the electronic communication 313 initiated at step 308 could be the transmission of an audio multimedia text message to the remote electronic device 314 belonging to the first person 309. The electronic communication 313 could likewise be a video call with the remote electronic device 314 belonging to the first person 309, and so forth. Other examples of electronic communications 313 that could be initiated at step 308 will be obvious to those of ordinary skill in the art having the benefit of this disclosure. Which type of electronic communication 313 is initiated in response to the lift gesture 123 can be user defined in a settings menu of the electronic device 110 in one or more embodiments.

As illustrated and described in FIG. 3, one or more processors (201) of the electronic device 110 present, at step 301, an image 311 from an image content file 312. In this illustrative embodiment, as shown at step 302, the image 311 depicts representations of multiple persons, namely, a first person 309 and a second person 310.

At step 304, one or more sensors (207) of the electronic device 110 detect user input 322 interacting with the display 109 of the electronic device 110 at one or more locations corresponding to the representations of the one or more persons depicted in the image 311 of the image content file 312. In this illustrative example, the user input 322 comprises touch input being delivered to the display 109 of the electronic device 110 and selecting the first person 309 from the image 311. As noted above, in one or more embodiments the touch input may be required to occur for at least a predefined duration, such as 350 milliseconds. In other embodiments, especially where there is only one person represented in the image 311, the user input 322 interacting with the display 109 can take other forms, e.g., a user gaze (122) being directed toward the display 109.

Using the method 300 of FIG. 3, all an authorized user 121 of the electronic device 110 need do to initiate an electronic communication 313 with a remote electronic device 314, e.g., a smartphone belonging to the first person 309, is simply touch the display 109 at a location corresponding to the first person 309 and execute the lifting gesture 123 lifting the electronic device 110 from the first position 124 to the second position 125. There is no need to manually switch from the presentation of the image 311 of the image content file 312 to another application, manually look up the communication identifier 127, switch to another application, enter the communication identifier 127, and then manually initiate the electronic communication 313. Instead, all that is required is a touch (step 303) and a lift (step 305). In response thereto, one or more processors of the electronic device 110 initiate communication with a remote electronic device 314 belonging to the first person 309 depicted in the image 311 of the image content file 312 being depicted on the display 109 of the electronic device 110. The method 300 of FIG. 1 advantageously provides an intuitive, frictionless, and simple way to initiate an electronic communication 313.

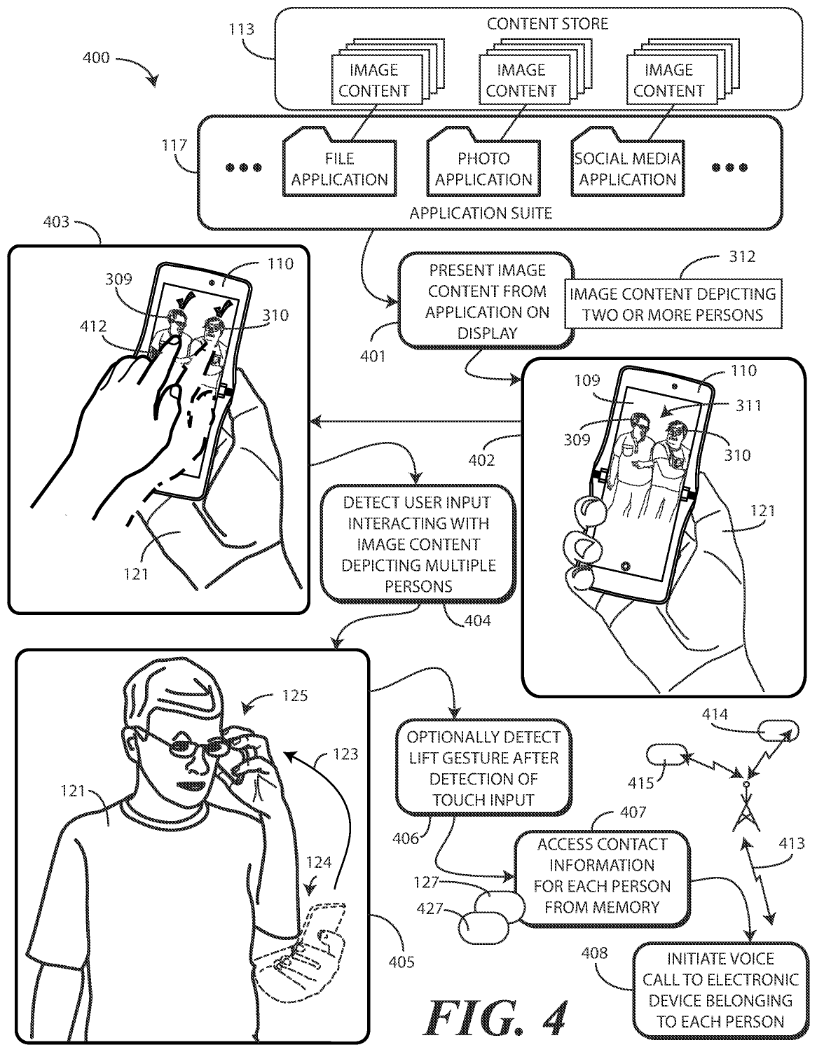

Turning now to FIG. 4, illustrated therein is yet another method 400 configured in accordance with one or more embodiments of the disclosure. The method 400 of FIG. 4 is similar to the method (300) of FIG. 3. However, rather than initiating an electronic communication (313) with a single remote electronic device (314) belonging to the first person (309), as was the case in the method (300) of FIG. 3, the method 400 of FIG. 4 allows the authorized user 121 of the electronic device 110 to initiate a group communication with multiple external electronic devices.

At step 401 one or more processors of an electronic device 110 again present on a display 109 of the electronic device 110 an image 311 of an image content file 312, which is shown at step 402. Regardless of whether the image content file 312 includes a single image, multiple images, video or other content, in one or more embodiments the image content file 312 is a static file stored in a content store 113 residing in a memory (204) of the electronic device 110. In one or more embodiments, the static file is associated with an application of an application suite 117 operable on the one or more processors (201) of the electronic device 110.

In the illustrative embodiment of FIG. 4, the image 311 of the image content file 312 depicts two persons, namely, a first person 309 and a second person 310. As before, to provide a simple, intuitive, and frictionless electronic communication initiation feature, one or more sensors (207) of the electronic device 110 detect user input interacting with the display 109 at one or more locations corresponding to the representations of the first person 309 and the second person 310 on the display 109 at step 404. As before, this user input can occur in a variety of ways. These ways include delivering a user gaze (122) to the display 109, touch input to the electronic device 110, voice input to the electronic device 110, or other techniques.

In the illustrative embodiment of FIG. 4, the authorized user 121 of the electronic device 110 desires to initiate a phone call with both the first person 309 and the second person 310. Accordingly, at step 403 the authorized user 121 is delivering user input 412 interacting with the display 109 by delivering touch input to two locations corresponding to the representations of the first person 309 and the second person 310, respectively. This touch input selects both the first person 309 and the second person 310 as those persons with whom the authorized user 121 of the electronic device 110 would like to initiate a voice call. In one or more embodiments, the one or more processors (201) of the electronic device 110 can memorialize the user selections via the presentation of a selection confirmation indicator, which is illustratively shown as a check mark at step 403 but can take other forms as well.

As before, in one or more embodiments the method 400 can require that the authorized user 121 deliver the user input 412 for at least a predetermined duration to ensure that the authorized user 121 is intentionally delivering the user input 412 to the electronic device 110. This helps to prevent false triggering that may occur when the authorized user 121 merely accidentally brushes a finger or other object across the display 109 of the electronic device 110. Where this additional false trip protection is included, step 404 can include determining that the user input 412 occurred for at least a predetermined duration, such as 150 milliseconds, 350 milliseconds, 750 milliseconds, one, two, or three seconds.

At step 405, the authorized user 121 executes a lift gesture 123 lifting the electronic device 110 from a first position 124 to a second position 125. As with the embodiments of FIGS. 1 and 3, in the illustrative embodiment of FIG. 4 the second position 125 is more elevated than is the first position 124 by at least a predefined distance. This allows the authorized user 121 to see the display 109 of the electronic device 110 when the electronic device 110 is in the first position 124, while being able to hear audio from an earpiece loudspeaker when the electronic device 110 is in the second position 125, as previously described.

At step 406, one or more motion sensors (209) of the electronic device 110 detect the lift gesture 123 lifting the electronic device 110 from the first position 124 to the second position 125. At step 407, one or more processors (201) of the electronic device 110 retrieve, from a memory (204) of the electronic device 110, a communication identifier 127 associated with a remote electronic device belonging to the first person 309, as well as another communication identifier 427 that is associated with a remote electronic device belonging to the second person 310. Both the communication identifier 127 and the other communication identifier 427 are retrieved because both the first person 309 and the second person 310 were selected by the authorized user 121 via the user input 412 delivered at step 403. In one or more embodiments, step 407 occurs in response to the detection of the user input 412 at step 404 and the detection of the lift gesture 123 detection occurring at step 406. Step 407 can occur in any of the ways previously described.

Once the selection process of step 407 selects the communication identifier 127 associated with the remote electronic device associated with the first person 309 and the other communication identifier 427 associated with the remote electronic device associated with the second person 310 is complete, the method 400 moves to step 408. In one or more embodiments, step 408 comprises the one or more processors (201) of the electronic device 110 causing the communication device (202) to initiate an electronic communication 413 in the form of a group call with both the remote electronic device 414 associated with the first person 309 and the remote electronic device 415 associated with the second person 310. In one or more embodiments, step 408 occurs in response to both the detection of the user input 412 interacting with the display 109 of the electronic device 110 at step 404 and the detection of the lift gesture 123 lifting the electronic device 110 from the first position 124 to the second position 125 at step 406.

In one or more embodiments, the initiation of the electronic communication 413 occurring at step 408 employs the communication identifier 127 and the other communication identifier 427 selected at step 407. For example, where the communication identifier 127 and the other communication identifier 427 are both telephone numbers, the initiation of the electronic communication 413 occurring at step 408 can employ those telephone numbers to initiate a group voice call to the remote electronic device 414 and the other remote electronic device 415. The electronic communication 413 initiated at step 408 can take any of the forms previously described.

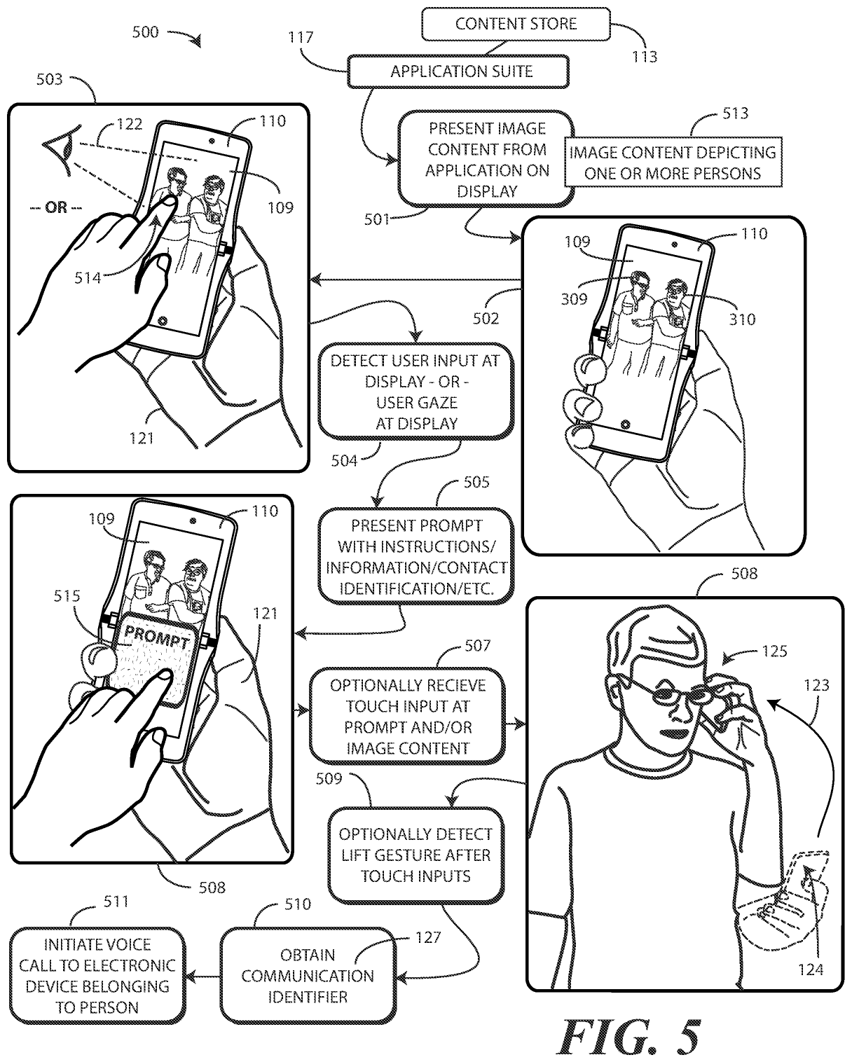

Turning now to FIG. 5, illustrated therein is another method 500 configured in accordance with one or more embodiments of the disclosure. At step 501 one or more processors (201) of an electronic device 110 again present on a display 109 of the electronic device 110 an image 512 of an image content file 513, which is shown at step 502. Regardless of whether the image content file 513 includes a single image, multiple images, video or other content, in one or more embodiments the image content file 513 is a static file stored in a content store 113 residing in a memory (204) of the electronic device 110. In one or more embodiments, the static file is associated with an application of an application suite 117 operable on the one or more processors (201) of the electronic device 110.

In the illustrative embodiment of FIG. 5, the image 512 of the image content file 513 depicts two persons, namely, a first person 309 and a second person 310. As before, to provide a simple, intuitive, and frictionless electronic communication initiation feature, one or more sensors (207) of the electronic device 110 detect user input interacting with the display 109 at one or more locations corresponding to the representations of the first person 309 and the second person 310 on the display 109 at step 504. Also, as before, this user input can occur in a variety of ways. These ways include delivering a user gaze 122 to the display 109, touch input 514 to the display 109 of the electronic device 110, voice input to the electronic device 110, or other techniques. One or more sensors (207) of the electronic device 110 then detect this user input at step 504 as previously described.

In one or more embodiments, in response to the user input detected at step 504, the one or more processors (201) of the electronic device 110 present, at step 505, a prompt 515 on the display 109 of the electronic device 110. The prompt 515, the presentation of which is optional, is shown at step 506.

While optional, the presentation of a prompt 515 can offer many different advantages. Illustrating by example, the presentation of the prompt 515 can be helpful in that it provides an indication to the authorized user 121 that a person depicted in the image 512 of the image content file 513 has been correctly identified. The prompt 515 can also obtain further clarification where, for example, two communication identifiers are associated with a person depicted in the image 512 of the image content file 513. In such situations, the prompt 515 can allow the authorized user 121 of the electronic device 110 to select which communication identifier should be used to initiate the electronic communication with the remote electronic device belonging to the person selected from the image 512 of the image content file 513. Turning briefly to FIG. 7, illustrated therein are several examples of prompts that can be used in accordance with embodiments of the disclosure.

Beginning with prompt 701, in one or more embodiments the prompt 701 can facilitate a selection of at least one person when a plurality of persons is depicted in the plurality of representations of the image (512) of the image content file (513). As shown at prompt 701, if the image (512) of the image content file (513) depicted three people, namely, Jessica, Nicole, and Kate, this prompt 701 provides their names and check boxes at which the authorized user (121) of the electronic device (110) may select one or more of Jessica, Nicole, and Kate to be included in an electronic communication. When such boxes are checked, this allows the one or more processors (201) of the electronic device (110) to receive the user selection of at least one person of the plurality of persons depicted in the plurality of representations of the image (512) of the image content file (513).

The prompt 701 may also include instructional indicia requesting that the authorized user (121) make such a selection. Said differently, in one or more embodiments the prompt 701 instructs an occurrence of a user selection of at least one person of the plurality of persons depicted in the image (512) of the image content file (513) with whom's electronic device should be engaged with an electronic communication. Illustrating by example, explanatory prompt 701 states, “Check boxes,” thereby requesting that the authorized user (121) check the persons with whom he would like to engage in a call.

The prompt 701 may also instruct an occurrence of the lifting gesture lifting the electronic device from the first position to the second position to initiate the electronic communication with the one or more persons selected by the user input. In this illustrative example, the instruction states, “then raise phone to ear to call,” thereby instructing the user to make the lifting gesture causing the one or more processors (201) of the electronic device (110) to cause the communication device (202) to initiate the electronic communication with the persons selected either with the user input at step (503) or via the selection at the prompt 701.

Prompt 702 also includes an instruction of the occurrence of the user selection of one or more persons of the plurality of persons depicted in the representations of the image (512) of the image content file (513). Rather than providing checkable boxes, however, the instruction requests that the authorized user (121) touch the images of the persons depicted in the representations of the image (512) of the image content file (513). Specifically, this instruction requests that the authorized user (121) touch the image of the persons to make the selection. As with prompt 701, prompt 702 allows the one or more processors (201) of the electronic device (110) to receive a user selection of at least one person of the plurality of persons depicted in the representations of the image (512) of the image content file (513). The authorized user (121) may respond, for example, much in the same way he did at step (303) of FIG. 3 or step (403) of FIG. 4, where the authorized user (121) touched the image of the first person (309) and/or second person (310) to indicate that an electronic communication should commence with a remote electronic device belonging to one or both of the first person (309) or the second person (310). This instruction further informs the authorized user (121) that a group call can be accomplished simply by touching multiple persons, noting, “Touching multiple images will initiate a group call.”

Prompt 702 also comprises an instruction instructing an occurrence of the lift gesture (123) lifting the electronic device (110) from the first position (124) to the second position (125) to initiate the communication with the one or more persons depicted in the representations of the image (512) of the image content file (513). Here, the prompt 702 instructs, “then raise phone to ear to call.” This is but one example of an instruction instructing an occurrence of the lift gesture (123). Others no doubt will be obvious to those of ordinary skill in the art having the benefit of this disclosure.

Prompt 703 provides an example facilitating a selection of one or more communication identifiers associated with the one or more persons depicted in the representations of the image (512) of the image content file (513). Embodiments of the disclosure contemplate that a particular person may be associated with multiple communication identifiers. Illustrating by example, a particular person may have a work communication identifier, a home communication identifier, a mobile communication identifier, and other communication identifiers. Where this is the case, prompt 703 facilitates a selection of one or more communication identifiers associated with a particular remote electronic device belonging to a person selected from the one or more persons depicted in the representations of the image (512) of the image content file (513). In one or more embodiments, a default communication identifier can be established for each person in a contacts database, thereby rendering the presentation of prompt 703 optional or unnecessary.

The various prompts 701,702,703 of FIG. 7 are illustrative only. Numerous other examples of prompts will be obvious to those of ordinary skill in the art having the benefit of this disclosure. Illustrating by example, in yet another embodiment, the prompt may simply be a presentation of the communication identifiers associated with a person without an instruction, or vice versa.

Turning now back to FIG. 5, at step 506 the authorized user 121 delivers user input to the prompt 515. As noted above, this user input may select to which person depicted in the representations of the image 512 of the image content file 513 an electronic communication should be directed. Alternatively, the user input could select which communication identifier should be used for the electronic communication that will be directed to a remote electronic device belonging to a particular person depicted in the representations of the image 512 of the image content file 513. At step 507, the one or more processors (201) of the electronic device 110 receive the user input from step 506.

At step 508, the authorized user 121 executes a lift gesture 123 lifting the electronic device 110 from a first position 124 to a second position 125. As with previous embodiments, in the illustrative embodiment of FIG. 5 the second position 125 is more elevated than is the first position 124.

At step 509, one or more motion sensors (209) of the electronic device 110 detect the lift gesture 123 lifting the electronic device 110 from the first position 124 to the second position 125. At optional step 510, one or more processors (201) of the electronic device 110 retrieve, from a memory (204) of the electronic device 110, a communication identifier 127 (if not already selected via the prompt 515) associated with a remote electronic device belonging to the persons selected via the user input at step 503.

At step 511 comprises the one or more processors (201) of the electronic device 110 cause the communication device (202) to initiate an electronic communication remote electronic device(s) associated with the one or more persons selected via the user input at step 503 as previously described.

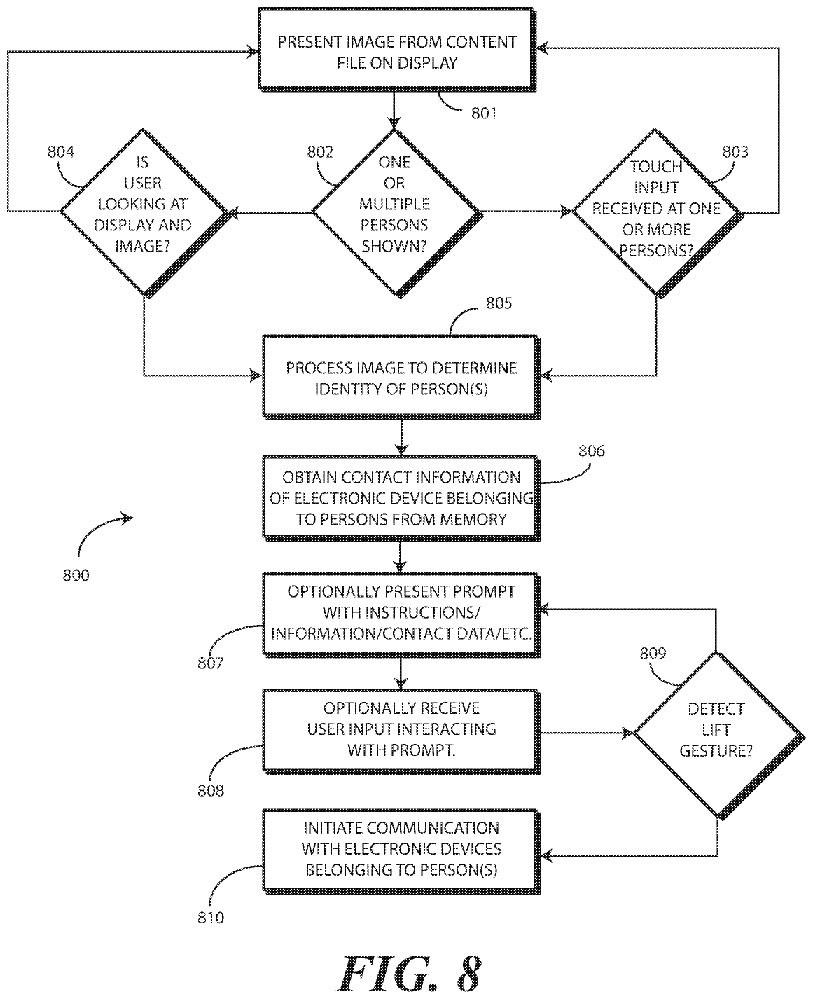

Turning now to FIG. 8, illustrated therein is a method 800 in accordance with one or more embodiments of the disclosure. Beginning at step 801, one or more processors of an electronic device present, on a display of the electronic device, an image depicting one or more persons. Decision 802 defines a branch in the method indicating how the method 800 can proceed in one or more embodiments as a function of the number of persons depicted in the image. If there is a single person depicted in the image, the method 800 proceeds to decision 804. If there are multiple persons depicted in the image, the method 800 proceeds to decision 803.

Both decision 803 and decision 804 identify, using one or more sensors of the electronic device, whether user input interacting with the depictions of the one or more persons is occurring. If, for example, only one person is depicted in the image, in one or more embodiments the user input interacting with the image and/or display can comprise a user gaze being directed to the image and/or display. Accordingly, in one or more embodiments decision 804 can determine if the authorized user of the electronic device is looking toward the image or the display in one or more embodiments.

By contrast, in some embodiments where the image depicts a plurality of representations of person, the user input interacting with the image and/or display can comprise touch input being delivered to the display. Accordingly, in one or more embodiments decision 803 determines whether the authorized user of the electronic device touches the depictions of one or more persons occurring as representations in the image.

At step 805, the method determines the identity of either the single person (if the method 800 proceeded through decision 804) or those persons selected from the image (if the method 800 proceeded through decision 803). Techniques for performing this step 805, any of which could be used here, have been described above. Step 806 then identifies one or more communication identifiers associated with one or more remote electronic devices associated with either the single person (if the method 800 proceeded through decision 804) or those persons selected from the image (if the method 800 proceeded through decision 803). Techniques for performing this step 806, any of which could be used here, have also been described above.

Optional step 807 presents a prompt on the display after detecting the user input via decision 803 or decision 804. As noted above, this prompt could prompt for a selection of at least one person of the one or more persons if the method 800 proceeded through decision 803. Alternatively, the prompt could instruct that a lift gesture lifting the electronic device from a first position to a second, more elevated position to initiate an electronic communication with a remote electronic device should occur. The prompt could facilitate a selection of one or more communication identifiers associated with the remote electronic device. One or more processors of the electronic device can, in one or more embodiments, receive a user selection of at least one person depicted in the image via the prompt. Other examples of how the prompt can be used were described above with reference to FIG. 7. Still others will be obvious to those of ordinary skill in the art having the benefit of this disclosure.

User input via the prompt is received at step 808. Said differently, in one or more embodiments step 808 comprises receiving, in response to the prompting at step 807, a selection of at least two persons via the prompt.

Decision 809 then detects, using one or more sensors of the electronic device, and after identifying user input interacting with the depictions of the one or more persons via decision 803 and decision 804 in one or more embodiments, whether a lifting gesture lifting the electronic device from a first position to a second position that is more elevated than the first position has occurred. Where it has not, the method 800 return to step 807, or if step 807 is omitted, to step 806. By contrast, where decision 809 detects the lifting gesture, step 810 can initiate, using a communication device, a communication to one or more remote electronic devices associated with either the single person (if the method 800 proceeded through decision 804) or those persons selected from the image (if the method 800 proceeded through decision 803) in response to the user input received via decision 803 or decision 804 and the lifting gesture detected at decision 809.

The method 800 can be used to make single calls or group calls. If the method 800 proceeded through decision 804, the communication initiated at step 810 could be a one-on-one call (or other type of communication as described above) to a remote electronic device belonging to the single person depicted in the image. By contrast, if the method 800 proceeded through decision 803, and the user input detected at this decision 803 selects at least two depictions of at least two persons depicted in the image, the communication initiated at step 810 could occur with two remote electronic devices associated with those two selected persons.

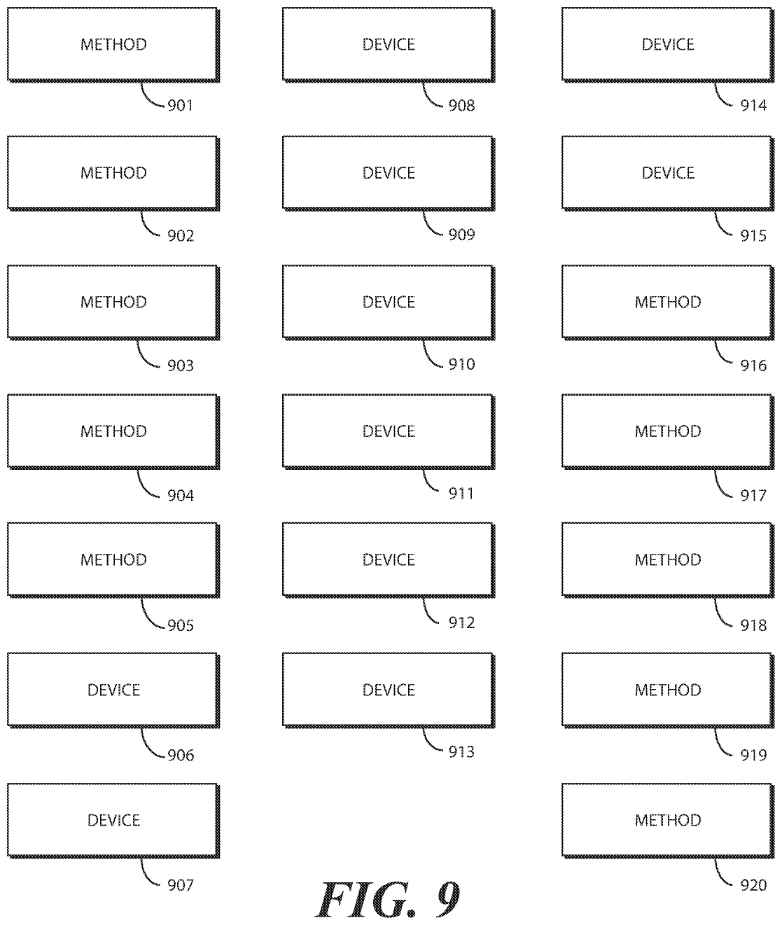

Turning now to FIG. 9, illustrated therein are various embodiments of the disclosure. The embodiments of FIG. 9 are shown as labeled boxes in FIG. 9 due to the fact that the individual components of these embodiments have been illustrated in detail in FIGS. 1-8, which precede FIG. 9. Accordingly, since these items have previously been illustrated and described, their repeated illustration is no longer essential for a proper understanding of these embodiments. Thus, the embodiments are shown as labeled boxes.

At 901, a method in an electronic device comprises presenting, by one or more processors on a display of the electronic device, an image of an image content file depicting a representation of one person. At 901, the method comprises detecting, with a gaze detector, a user gaze being directed toward the display.

At 901, the method comprises detecting, with one or more motion sensors after detecting the user gaze being directed toward the display, a lift gesture lifting the electronic device from a first position to a second position. At 901, in response to detecting both the user gaze being directed toward the display and the lift gesture lifting the electronic device from the first position to the second position, the method comprises initiating electronic communication with a remote electronic device associated with the person.

At 902, the method of 901 further comprises, in response to detecting the user gaze being directed toward the display, retrieving, with the one or more processors from a memory of the electronic device, a communication identifier associated with the remote electronic device. At 902, the initiating the electronic communication with the remote electronic device of 901 employs the communication identifier.

At 903, the method of 901 further comprises presenting, with the one or more processors in response to detecting the user gaze being directed toward the display, a prompt on the display. At 904, the prompt of 903 instructs the lift gesture lifting the electronic device from the first position to the second position to initiate the electronic communication with the remote electronic device. At 905, the prompt of 903 facilitates selection of one or more communication identifiers associated with the remote electronic device.

At 906, an electronic device comprises a display, one or more sensors, and a communication device. At 906, the electronic device comprises one or more processors operable with the display, the one or more sensors, and the communication device, as well as a memory operable with the one or more processors.

At 906, the one or more processors present, on the display of the electronic device, an image from an image content file. At 906, the image depicts representations of one or more persons.

At 906, the one or more sensors detect user input interacting with the display at one or more locations corresponding to the representations of the one or more persons, and thereafter, a lifting gesture lifting the electronic device from a first position to a second, more elevated position. At 906, the one or more processors cause, in response to the one or more sensors detecting the user input and the lifting gesture, the communication device to initiate communication with one or more remote electronic devices associated with the one or more persons depicted in the image.

At 907, the representations of the one or more persons of 906 comprise a representation of only one person. At 907, the user input interacting with the display at 906 comprises a user gaze being directed toward the display.

At 908, the representations of the one or more persons of 906 comprise a plurality of representations of a plurality of persons. At 908, the user input interacting with the display of 906 comprises touch input being delivered to the display. At 909, the touch input of 908 occurs for at least a predefined duration.

At 910, the one or more processors of 908 further present, in response to the touch input, a prompt on the display. At 911, the prompt of 910 facilitates a selection of at least one person of the plurality of persons depicted in the plurality of representations. At 912, the one or more processors of 911 receive a user selection of the at least one person of the plurality of persons depicted in the plurality of representations at the prompt. At 912, the one or more remote electronic devices of 911 are associated with the at least one person of the plurality of persons identified by the user selection.

At 913, the prompt of 910 instructs an occurrence of the user selection of the at least one person of the plurality of persons depicted in the plurality of representations. At 914, the prompt of 913 further instructs an occurrence of the lifting gesture lifting the electronic device from the first position to the second, more elevated position to initiate the communication with the one or more remote electronic devices associated with the one or more persons depicted in the image.

At 915, the representations of the one or more persons of 906 comprise a plurality of representations of a plurality of persons. At 915, one of the representations comprises a representation of an authorized user of the electronic device. At 915, the one or more remote electronic devices are associated with persons other than the authorized user of the electronic device.

At 916, a method in an electronic device comprises presenting, on a display of the electronic device, an image depicting one or more persons. At 916, the method comprises identifying, with one or more sensors of the electronic device, user input interacting with depictions of the one or more persons. At 916, the method comprises identifying, with one or more processors, one or more communication identifiers associated with one or more remote electronic devices associated with the one or more persons depicted in the image.

At 916, the method comprises detecting, with the one or more sensors after identifying the user input interacting with the depictions of the one or more persons, a lifting gesture lifting the electronic device from a first position to a second position that is more elevated that the first position. At 916, the method comprises initiating, with a communication device, a communication to the one or more remote electronic devices using the one or more communication identifiers in response to the user input and the lifting gesture occurring.

At 917, the user input of 916 selects at least two depictions of at least two persons depicted in the image. At 917, the communication initiated by the communication device occurs with at least two electronic devices associated with the at least two persons.

At 918, the method of 917 further comprises presenting selection confirmation identifiers, at the display, indicating that the at least two persons have been selected by the user input. At 919, the method of 916 further comprises prompting, at the display of the electronic device, for a selection of at least one person of the one or more persons. At 920, the method of 919 further comprises receiving, in response to the prompting, a selection of at least two persons, wherein the communication initiated by the communication device occurs with at least two electronic devices associated with the at least two persons.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For instance, the methods illustrated above included an automatic commencement of the electronic communication in response to the detection of a lift gesture lifting the electronic device from a first position to a second, more elevated position. While this is one trigger mechanism for initiating the electronic communication, embodiments of the disclosure are not so limited. In one or more alternate embodiments, additional features can be provided.

Illustrating by example, in one embodiment the one or more processors can present call options in the form of a prompt on the display in response to detecting the user input. In embodiments such as when the authorized user is wearing a headset, the prompt may facilitate the initiation of the electronic communication without the detection of the lifting gesture since the person may not need to lift the electronic device to hear audio from the electronic communication.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A method in an electronic device, the method comprising:
presenting, by one or more processors on a display of the electronic device, an image of an image content file stored in an application of an application suite and depicting a representation of one person, the application of the application suite comprising one of a photography or video application or a social media application;
detecting, with a gaze detector, a user gaze being directed toward the display;
detecting, with one or more motion sensors after detecting the user gaze being directed toward the display, a lift gesture lifting the electronic device from a first position to a second position;
detecting, with one or more proximity sensors, an ear being adjacent to the electronic device after detecting the lift gesture; and
in response to detecting the user gaze being directed toward the display, the lift gesture lifting the electronic device from the first position to the second position, and the ear being adjacent to the electronic device;
retrieving, from another application of the application suite, a communication identifier associated with a remote electronic device associated with the one person, wherein the application of the application suite and the another application of the application suite are different applications; and
initiating electronic communication with the remote electronic device associated with the person using the communication identifier retrieved from the another application;
wherein detection of the ear being adjacent to the electronic device is a condition precedent to initiating the electronic communication.

2. The method of claim 1, wherein the another application comprises a contact application of the application suite, wherein the retrieving the communication identifier associated with the remote electronic device occurs by cross referencing the image with depictions stored in the contact application suite of the electronic device.

3. The method of claim 1, further comprising presenting, with the one or more processors in response to detecting the user gaze being directed toward the display, a prompt on the display.

4. The method of claim 3, the prompt instructing the lift gesture lifting the electronic device from the first position to the second position to initiate the electronic communication with the remote electronic device.

5. The method of claim 3, the prompt facilitating selection of one or more communication identifiers associated with the remote electronic device.

6. An electronic device, comprising:
a display;
one or more sensors;
a communication device;
one or more processors operable with the display, the one or more sensors, and the communication device; and
a memory operable with the one or more processors;
the one or more processors presenting, on the display of the electronic device, an image from an image content file selected from an application of an application suite other than a contact application, the image depicting representations of a plurality of persons;
the one or more sensors detecting user input interacting with the display at one or more locations corresponding to the representations of the plurality of persons and, thereafter, a lifting gesture lifting the electronic device from a first position to a second, more elevated position; and
the one or more processors causing, in response to the one or more sensors detecting the user input and the lifting gesture, the communication device to initiate communication with one or more remote electronic devices associated with one or more persons depicted in the image.

7. The electronic device of claim 6, wherein the image from the image content file is not a real-time, dynamically occurring image presentation.

8. The electronic device of claim 6, wherein the user input interacting with the display comprises touch input being delivered to the display.

9. The electronic device of claim 8, the touch input occurring for at least a predefined duration of three hundred milliseconds.

10. The electronic device of claim 8, the one or more processors presenting, in response to the touch input, a prompt on the display.

11. The electronic device of claim 10, the prompt facilitating a selection of at least one person of the plurality of persons depicted in the representations.

12. The electronic device of claim 11, the one or more processors receiving a user selection of the at least one person of the plurality of persons depicted in the representations at the prompt, wherein the one or more remote electronic devices are associated with the at least one person of the plurality of persons identified by the user selection.

13. The electronic device of claim 11, the prompt instructing an occurrence of the selection of the at least one person of the plurality of persons depicted in the representations.

14. The electronic device of claim 13, the prompt further instructing an occurrence of the lifting gesture lifting the electronic device from the first position to the second, more elevated position to initiate the communication with the one or more remote electronic devices associated with the one or more persons depicted in the image.

15. The electronic device of claim 6, wherein:
the representations of the plurality of persons comprising a plurality of representations of a plurality of persons, with the plurality of representations comprising a representation of an authorized user of the electronic device; and
the one or more remote electronic devices are associated with persons other than the authorized user of the electronic device.

16. A method in an electronic device, the method comprising:
presenting, on a display of the electronic device, an image depicting one or more persons from an application of an application suite other than a contact application;
identifying, with one or more sensors of the electronic device, user input interacting with depictions of the one or more persons;
initiating, with one or more processors, a timer in response to identifying the user input interacting with the depictions of the one or more persons;
determining, by the one or more processors, whether the timer has expired while the user input interacting with the depictions of the one or more persons is still occurring;
detecting, with the one or more sensors after identifying the user input interacting with the depictions of the one or more persons, a lifting gesture lifting the electronic device from a first position to a second position that is more elevated that the first position;
identifying, with the one or more processors, one or more communication identifiers associated with one or more remote electronic devices associated with the one or more persons depicted in the image from the contact application after detecting the lift gesture;
initiating, with a communication device, a communication to the one or more remote electronic devices using the one or more communication identifiers in response to the user input and the lifting gesture occurring only when the timer expired while the user input interacting with the depictions of the one or more persons was still occurring.

17. The method of claim 16, wherein:
the user input selects at least two depictions of at least two persons depicted in the image; and
the communication initiated by the communication device occurs with at least two electronic devices associated with the at least two persons.

18. The method of claim 17, further comprising presenting selection confirmation identifiers, at the display, indicating that the at least two persons have been selected by the user input.

19. The method of claim 16, further comprising prompting, at the display of the electronic device, for a selection of at least one person of the one or more persons.

20. The method of claim 19, further comprising receiving, in response to the prompting, a selection of at least two persons, wherein the communication initiated by the communication device occurs with at least two electronic devices associated with the at least two persons.
